(19) United States
(12) Patent Application Publication
(10) Pub. No.: US 2004/0003165 A1
(43) Pub. Date: Jan. 1, 2004

(54) Memory subsystem including error correction

(76) Inventors: Jurgen M. Schulz, Pleasanton, CA (US); Robert E. Cypher, Saratoga, CA (US); Drew G. Doblar, San Jose, CA (US); Emrys Williams, Eversholt (GB)

Correspondence Address: B. Noel Kivlin, Meyertons, Hood, Kivlin,, Kowert & Goetzel, P.C., P.O. Box 398, Austin, TX, 78767, US

(21) Appl. No.: 10/328,684

(22) Filed: Dec. 23, 2002

Related U.S. Application Data
(60) Provisional application No. 60/392,450, filed on Jun. 28, 2002.

(51) Int. Cl. G06F 12/00

(52) U.S. Cl. 711/5; 711/114

(57) ABSTRACT

A memory subsystem including error correction. A memory subsystem includes a memory controller and system memory including a plurality of memory modules. The system memory may be coupled to the memory controller by a memory interconnect. Each of the plurality of memory modules includes a circuit board and a plurality of memory chips mounted to the circuit board. The memory controller may store portions of a data segment across at least two of the memory modules. The memory controller may further store parity of the portions of the data segment in a corresponding location of another of the memory modules.

### BACKGROUND OF THE INVENTION

1. Field of the Invention

This invention relates to computer system memory and, more particularly, to memory subsystems including memory modules.

2. Description of the Related Art

Computer systems are typically available in a range of configurations which may afford a user varying degrees of reliability, availability and serviceability (RAS). In some systems, reliability may be paramount. Thus, a reliable system may include features designed to prevent failures. In other systems, availability may be important and so systems may be designed to have significant fail-over capabilities in the event of a failure. Either of these types of systems may include built-in redundancies of critical components. In addition, systems may be designed with serviceability in mind. Such systems may allow fast system recovery during system failures due to component accessibility. In critical systems, such as high-end servers and some multiple processor and distributed processing systems, a combination of the above features may produce the desired RAS level.

In many computer systems, one or more processors may be connected to a memory subsystem through a system bus. For example, FIG. 1 illustrates a typical computer system configuration. Computer system 10 includes a plurality of processors 20A-20n connected to a memory subsystem 50 via a system bus 25. Memory subsystem 50 includes a memory controller 30 coupled to a system memory 40 via a memory interconnect 35. It is noted that elements referred to herein with a particular reference number followed by a letter may be collectively referred to by the reference number alone. For example, processor 20A-n may be collectively referred to as processor 20.

Generally speaking, processor 20 may access memory subsystem 50 by initiating a memory request transaction such as a memory read or a memory write to memory controller 30 via system bus 25. Memory controller 30 may then control the storing to and retrieval of data from system memory 40 by issuing memory request commands to system memory 40 via memory interconnect 35. Memory interconnect 35 may convey address and control information and data between system memory 40 and memory controller 30.

Memory subsystem 30 may be configured to store data and instruction code within system memory 40 for use by processor 20. In many computer systems, system memory 40 may be implemented using expandable blocks of memory such as a plurality of dual in-line memory modules (DIMM). Each DIMM may employ a plurality of random access memory chips such as dynamic random access memory (DRAM), for example. Each DIMM may be mated to a system memory board via an edge connector and socket arrangement. The socket may be located on a memory subsystem circuit board and each DIMM may have an edge connector which may be inserted into the socket, for example.

The circuit board typically has contact pads or “fingers” arranged on both sides and along one edge of the circuit board. This edge of the circuit board is inserted into a socket having spring-loaded contacts for mating with the fingers. The socket arrangement allows the memory modules to be removed and replaced by a user. In many systems, the memory module connectors are mounted on a motherboard or system board such that the memory modules connect to a memory bus or interconnect one row after another or in a daisy chain. In some cases a computer system may be provided with a given number of memory modules and a user may add modules to expand the system memory capacity.

In many systems, to allow this expandability the memory modules are generally arranged into banks. The banks may be arranged such that each bank may include a particular range of addresses and so when a bank is added, additional memory space is added.

However in many typical bank arrangements, all the data signals in the data path are routed to each memory module socket. For example, in FIG. 2, a memory subsystem is shown. Memory subsystem 50 includes a memory controller 30 coupled to a system memory including DIMMs 0-3 via a data path having data signals DQ 0-63. It is noted that data signals DQ0-63 are coupled to each DIMM. In the illustrated embodiment, bank 0 corresponds to DIMM 0, bank 1 corresponds to DIMM 1 and so forth. Within each DIMM, DQ 0-15 may correspond to a group of DRAM chips such as DRAM chips 0-3 and DQ 16-31 may correspond to DRAM chips 4-7 and so on. Thus if each data signal path or circuit board trace connected to a memory module socket is a transmission line, then each socket connection point on that transmission line may represent a stub.

Therefore in FIG. 2, each signal in data path DQ0-63 may have as many as four stubs. For systems containing a small number of memory modules, or a narrow data bus, the daisy chain configuration described above may not present any problems. However, in systems with a wide data bus and with many memory modules, a daisy chain configuration may present problems. Each stub in a signal's path may cause undesirable effects such as distortion on signal edges. This type of signal degradation may in turn cause system performance to suffer.

Further in some systems, a faulty memory subsystem component such as a memory module, for example, may cause a catastrophic failure to occur. In other systems, a faulty memory module may cause a system shutdown or may necessitate a system shutdown. These types of system responses to memory faults may be unacceptable in systems expected to have high RAS levels.

### SUMMARY OF THE INVENTION

Various embodiments of a memory subsystem including error correction are disclosed. In one embodiment, a memory subsystem includes a memory controller and system memory including a plurality of memory modules. The system memory may be coupled to the memory controller by a memory interconnect. Each of the plurality of memory modules includes a circuit board and a plurality of memory chips mounted to the circuit board. The memory controller may store portions of a data segment across at least two of the memory modules. The memory controller may further store parity of the portions of the data segment in a corresponding location of another of the memory modules.

In another embodiment, the memory subsystem includes a memory controller and system memory including a plurality of memory modules. The system memory may be coupled to the memory controller by a memory interconnect. Each of the plurality of memory modules includes a circuit board and a plurality of memory chips mounted to the circuit board. The memory controller may access the system memory in a plurality of slices. Each slice may include at least one memory module. The memory controller may also store parity of at, least some of the plurality of slices in at least one additional slice.

### BRIEF DESCRIPTION OF THE DRAWINGS

FIG. 1 is a block diagram of a computer system.

FIG. 2 is a block diagram of a memory subsystem.

FIG. 3 is a block diagram of one embodiment of a memory subsystem.

FIG. 4 is a block diagram of another embodiment of a memory subsystem.

FIG. 5 is a block diagram of one embodiment of a memory module.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

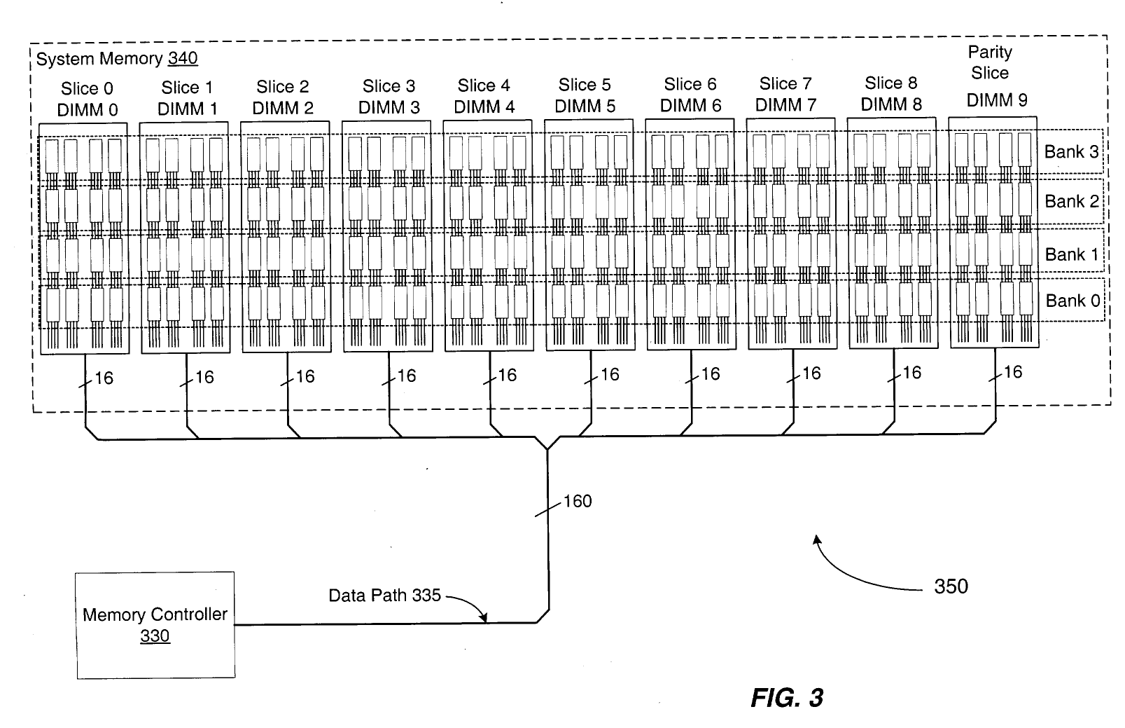

Referring to FIG. 3, a block diagram of one embodiment of a memory subsystem 350 is shown. Memory subsystem 350 includes a memory controller 330 coupled to a system memory 340 via a data path 335 including 160 data signals. System memory 340 includes 10 DIMMs designated DIMM 0 through DIMM 9. It is noted that although only data path 335 is shown coupled to system memory 340, other signals (e.g. address and control signals) may be coupled between system memory 340 and memory controller 330. It is further noted that alternative embodiments may include other numbers of DIMMs and that data path 335 may include other numbers of data signals.

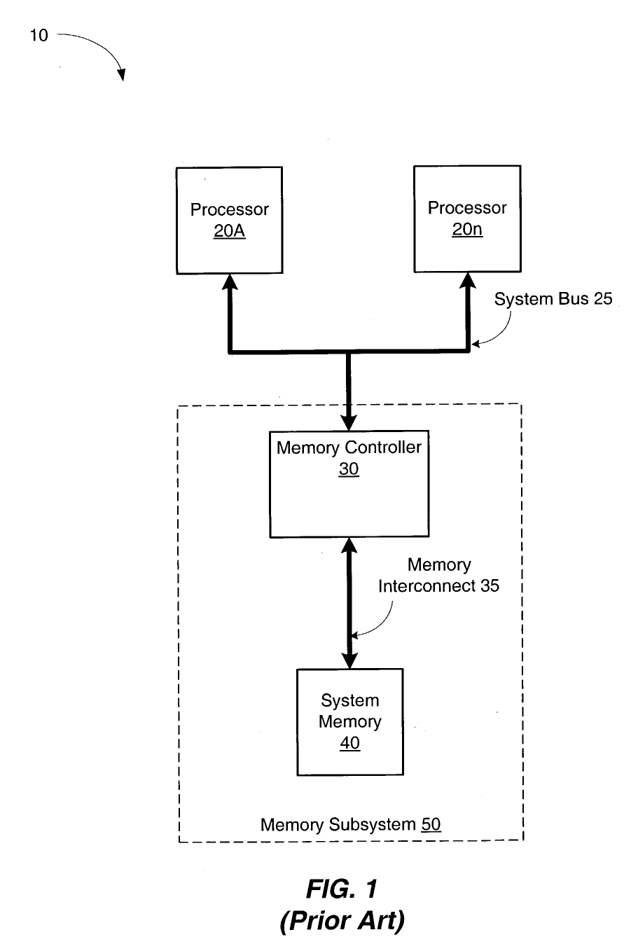

Memory controller 330 may generate memory request operations in response to receiving memory requests from devices such as processor 20A or 20B of FIG. 1, for example. It is noted that memory controller 330 may also receive requests from other sources such as I/O devices (not shown). Memory controller 330 may also schedule the requests and generate corresponding memory requests for transmission on data path 335. The requests may include address and control information (not shown in FIG. 3). For example, if the memory request is a memory read, memory controller 330 may generate one or more requests that include the requested address within system memory and corresponding control information such as such as start-read or pre-charge commands, for example.

In the illustrated embodiment, the 160 data signals included in data path 335 are grouped into 10 groups of 16 data signals. Each group of 16 data signals represents a respective mutually exclusive set of data signals. Each respective mutually exclusive set of data signals is coupled to a different DIMM. Thus each DIMM is coupled to a portion of data path 335. The data conveyed on data path 335 may be referred to as a data segment, while the data conveyed on each of those groups of 16 data signals may be referred to as a portion.

In the illustrated embodiment, the 10 DIMMs of system memory 340 are grouped according to the 16 data signals to which they are each coupled. Thus there are 10 pieces or portions. Each piece is be referred to herein as a “slice.” In one embodiment, each slice may include the data stored within one DIMM. Each DIMM may be configured to store a portion of the data corresponding to that portion of data path 335 which is coupled to it. For example, DIMM 0 is coupled to 16 data signals, such as DQ 0-15, for example. In one embodiment, the 16 data signals and DIMM 0 may represent slice 0. Further, DIMM 1 and its associated data signals may correspond to slice 1 and so forth. In addition, one slice is designated as a parity slice. In one embodiment, DIMM 9 and its associated data signals represent parity of slices 0-8. It is noted that in other embodiments, other slices may be used as parity slices.

It is noted that in an alternative embodiment, each of the 16 data signals coupled to a DIMM may be logically divided into two or more portions or slices. In such an alternative embodiment, each DIMM may be used to store two or more slices. For example, if a memory module has 10 DIMMs (0-9), DIMM 0 may be coupled to 16 data signals, such as DQ 0-15. These 16 data signals may include two portions of 8 data signals each. The 16 data signals and DITMM 0 may represent slice 0 and slice 1. Further, DIMM 1 and its associated data signals may correspond to slice 2 and slice 3 and so forth. In addition, one DIMM may be designated as a parity DIMM. Thus in such an embodiment, DIMM 9 and its associated data signals may represent parity of slices 0-15.

The parity slice is configured to convey and store data information which is redundant to the data information stored in DIMMs 0-8. In one embodiment, the parity information may be generated using the Boolean properties of the Exclusive Or (XOR) function such that if ‘A’ XOR ‘B’ XOR ‘C’=‘D’, then ‘D’ XOR ‘B’XOR ‘C’=‘A’. Thus if ‘A’ has errors, it may be recreated using ‘D, B and C’. Thus, using the XOR function, all the bits of one slice may be recreated using only the other slices and the redundant slice information (e.g. the parity data information). In the illustrated embodiment, the parity data information stored in DIMM 9 is the Exclusive—OR of the data stored in DIMMs 0-8.

It is noted that in an alternative embodiment, more than one slice may be used to convey redundant data information. For example, each redundant slice may include redundant data information of a subset of the other remaining slices, such that the cumulative redundant information contains all the subsets and all of the information. Thus in such an embodiment, it may be possible to reconstruct more than one bad slice.

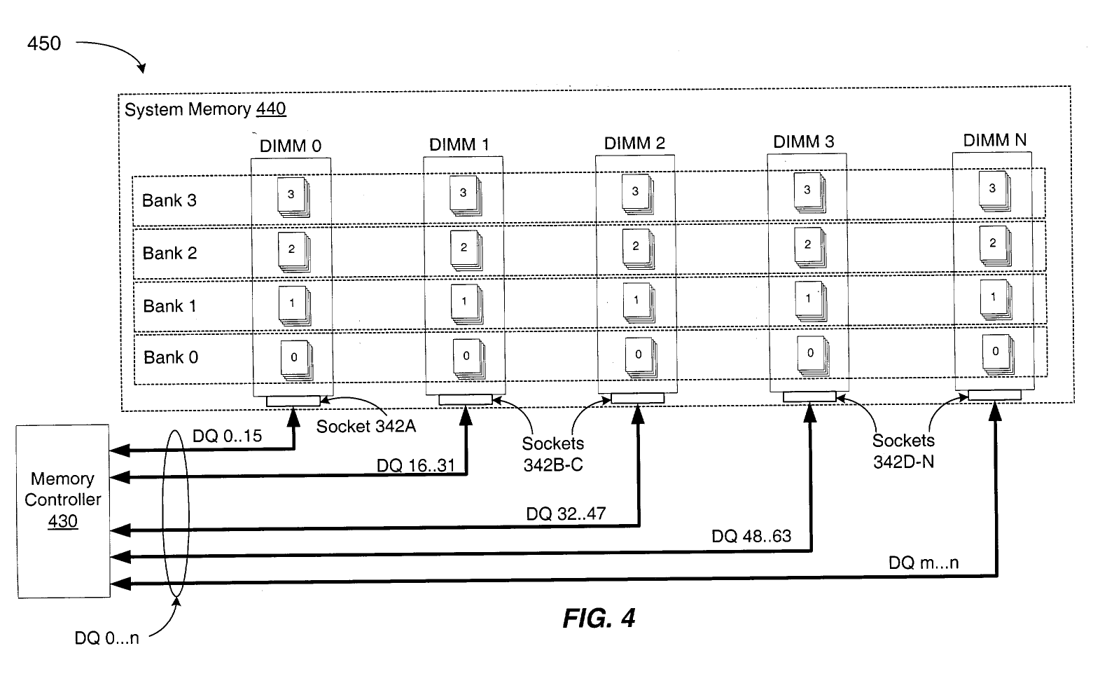

Referring to FIG. 4, a block diagram of one embodiment of a memory subsystem 450 is shown. Memory subsystem 450 includes a memory controller 430 coupled to a system memory 440 via a data path including data signals DQ 0-n. It is noted that in addition to the data path signals DQ0-n, other signals (e.g. address and control signals) may be coupled between system memory 440 and memory controller 430.

In the illustrated embodiment, system memory 440 includes a number of memory modules, designated DIMM 0 through DIMM N. The N refers to any number of DIMMs. Each of DIMMs 0-N may include 16 memory integrated circuit chips, although it is noted that other embodiments are contemplated that include other numbers of memory chips on each DIMM. On DIMM 0, the memory chips may be arranged into four groups of four chips and designated 0-3. The memory chips are examples of any type of DRAM chip such as synchronous DRAM (SDRAM) or double data rate (DDR) SDRAM, for example.

In one embodiment, the data path conveys 16 data signals between memory controller 430 and each DIM M within system memory 440. For example, data path DQ0-15 is coupled between memory controller 430 and DIMM 0, DQ 16-31 is coupled between memory controller 430 and DIMM 1 and so on. Thus, in the illustrated embodiment, each group of data signals is a point-to-point data path from memory controller 430 to a respective DIMM. It is noted that other embodiments are contemplated which include other numbers of data signals being conveyed to each DIMM.

In one embodiment, each DIMM of system memory 440 is arranged into 4 external banks, designated banks 0-3. Each bank includes four memory chips from each DIMM. In addition, each memory chip may have internal banks. Each DIMM receives a mutually exclusive subset of the total number of data signals DQ 0-n in the data path. Therefore, each of banks 0-3 spans across DIMM 0-N. In addition, depending upon the number of memory chips used on each DIMM, each bank may include other numbers of memory chips.

As described above, each connection point in a signal path may represent a stub in a transmission line, which may degrade signal integrity and system performance. By allowing an external bank to span all the DIMMs, a given group of data signals within a data path of a memory interconnect may be routed to a single DIMM. This type of bank arrangement may eliminate connection points in each data signal path which may be present in a typical system memory which has external banks allocated to a single DIMM. Thus by removing some of these stubs, overall memory performance may be increased due to improved signal integrity of the data signals.

As will be described further below, each DIMM may include logic (not shown in FIG. 4) configured to control bank selection and addressing of the memory chips. In addition, dependent upon the type of DRAM memory chips used, address and control signals may include address (addr), row address strobe (ras), column address strobe (cas), write enable (we) and chip select (es), for example.

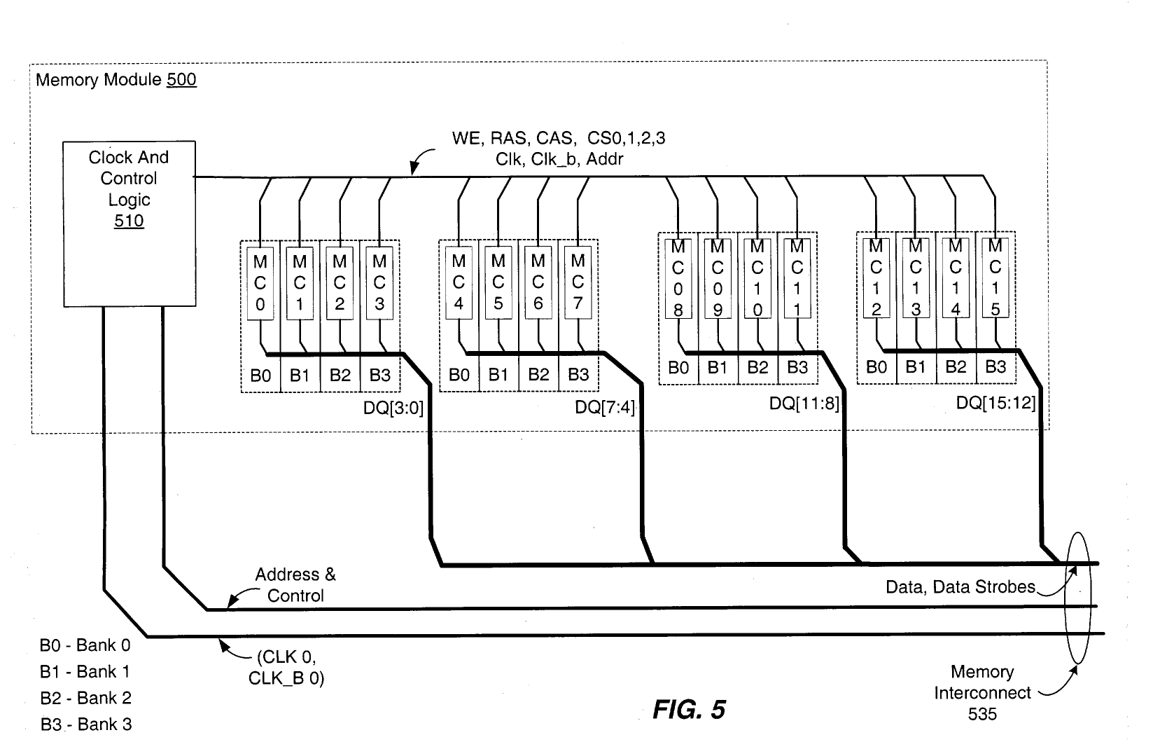

Turning to FIG. 5, a block diagram of one embodiment of a memory module of FIG. 3 and FIG. 4 is shown. Memory module 500 includes a plurality of memory chips, designated MC 0-15 coupled to a clock and control logic unit 510. Memory module 500 is coupled to receive address and control information and to receive and send data and data strobes via memory interconnect 535. The data lines are designated DQ [15:0]. It is noted that the illustrated arrangement of MC 0-15 and clock and control logic 510 shown in FIG. 5 is only an exemplary arrangement for discussion purposes. It is contemplated that in other embodiments other physical arrangements of components may be used.

In the illustrated embodiment, MC 0-15 may be implemented in DDRSDRAM technology. Although it is noted that in other embodiments, MC 0-15 may be implemented in other types of DRAM. In such embodiments, other address and control signals (not shown) may be used.

Generally speaking, to access a DDRSDRAM device, a command encoding and an address must first be applied to the control and address inputs, respectively. The command is encoded using the control inputs. The address is then decoded, and data from the given address is accessed, typically in a burst mode.

In the illustrated embodiment, clock and control logic 510 may receive memory request encodings from a memory controller via memory interconnect 535. As described above, a memory request encoding may include an address and control information such as row address strobe (ras) column address strobe (cas), write enable (we) and chip select (cs) control signals. Clock and control logic 510 may generate appropriate control signals for accessing the appropriate bank of memory chips. In the illustrated embodiment, for example, write enable (WE), row address strobe (RAS), column address strobe (CAS) and chip selects (CS0, 1, 2 and 3) may be generated by clock and control logic 510 dependent upon the received address and control information. Further, clock and control logic 510 may receive clock signals such as clk 0 and clk_b 0 upon memory interconnect 535. Clock and control logic 510 may include clock logic such as a phase lock loop, for example, to generate clock signals for each of MC 0-15. It is noted that clock and control logic 510 may generate other signals (not shown) which may control MC 0-15 but have been left out for simplicity. A more detailed description of the operation of a DDRSDRAM device may be found in the JEDEC standard entitled “DDR SDRAM Specification” available from the JEDEC Solid State Technology Association.

In the illustrated embodiment, MC 0-15 are logically arranged into four external banks, designated banks 0-3. Bank 0 includes MC 0, 4, 8 and 12. Bank 1 includes MC 1, 5, 9 and 13 and so on. It is noted that CS0 may enable bank 0, CS 1 may enable bank 1, etc. As described above, memory module 500 is coupled only to one group of 16 data signals (e.g., DQ [15:0]) and each bank on a given memory module may be coupled to all 16 data signals connected to that memory module. For example, the data signals DQ [15:0] are distributed such that MC 0-3 are coupled to DQ [3:0], MC 4-7 are coupled to DQ [7:4], MC 8-11 are coupled to DQ [11:8] and MC 12-15 are coupled to DQ [15:12].

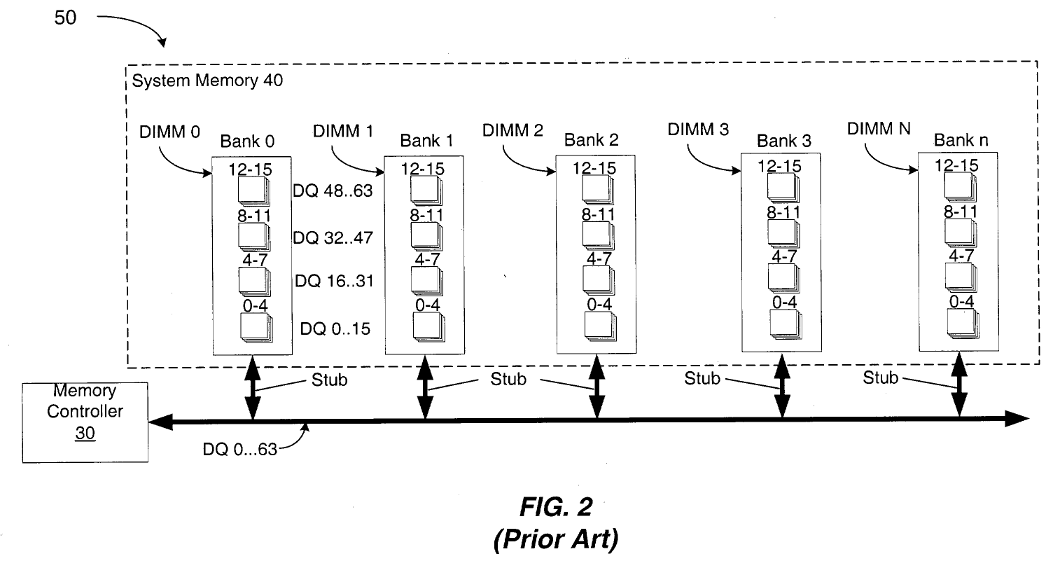

To improve system reliability and availability, many systems implement error codes in one form or another. It is noted that in one embodiment, an error code may be an error detection code capable of detecting at least one bit error in a group of bits. In another embodiment, and an error code may be an error correction code which is also an error detection code which is also capable of correcting the at least one detected bit error. For example, referring collectively to FIG. 1 through FIG. 5, during the storage of data, memory controller 330 of FIG. 3 may generate an error code which may be conveyed and stored with the data. In one embodiment, upon reading the data from system memory 340, memory controller 330 may check the validity of the data by regenerating and comparing the error code. Depending on the level of protection (i.e. error code strength), memory controller 330 may detect at least one bit error and correct at least one bit error in the data being read out of system memory 340. Alternatively, memory controller 330 may detect at least one bit error in the data being read out of system memory 340.

In another embodiment, errors may be detectable in the address and control information conveyed to a DIMM. Error codes conveyed with the data being stored to one or more DIMMs may not detect errors in the storage of data due to address and control errors. These errors may cause the data to be stored to a wrong address or not to be stored at all. In such an embodiment, a memory controller (e.g., memory controller 330) may convey address and control parity information (not shown) to the DIMMs with the address and control information. Accordingly, using the address and control parity information, a given DIMM may detect an address and control error and report it to the memory controller.

In addition, multiple data errors associated with one particular DIMM may exist. Errors of this magnitude may be caused by a bad memory chip, a bad DIMM socket connection or some other problem which affects the data path portion between any single DIMM and memory controller 330. In many cases, this type of error may be impractical to correct using error codes alone. However, memory controller 330 may use the associated error code to detect which DIMM may be faulty or which memory chip on a DIMM may be faulty. In addition, the error code may be used to detect certain types of bit errors in any of the DIMMs, before and after a DIMM failure. An exemplary error code which may be used in one specific implementation is discussed in U.S. patent application, Ser. No. 10/185,265 entitled “Error Detection/Correction Code which Detects and Corrects Component Failure and which Provides Single Bit Error Correction Subsequent to Component Failure” and in U.S. patent application, Ser. No. 10/184,674 entitled “Error Detection/Correction Code which Detects and Corrects Memory Module/Transmitter Circuit Failure” and in U.S. patent application, Ser. No. 10/185,959 entitled “Error Detection/Correction Code which Detects and Corrects a First Failing Component and Optionally a Second Failing Component” (filed concurrently herewith), the disclosures of which are incorporated herein by reference in their entirety.

If a memory controller detects errors or failure in a given slice, the parity data information conveyed and stored in the parity slice may be used in conjunction with the contents stored within the other non-failing slices to recreate the contents of the failed slice without using the contents of that failed slice. Accordingly, the parity slice may be used to correct multiple bit-errors that may come from a single slice.

Since errors associated with each of DIMMs 0-8 may be detected and the parity information may be conveyed and stored in DIMM 9, the data information from a faulty slice may be recreated on-the-fly by a memory controller such as memory controller 330 or memory controller 430. Thus, a memory subsystem may continue to operate with a faulty DIMM, DIMM socket connection or possibly even a faulty data port on a memory controller, for example.

In one embodiment, once a slice has been identified as being faulty, the data information from the faulty slice may continue to be reconstructed each time it is accessed until the problem is fixed. For example, in one embodiment, memory controller 330 of FIG. 3 or memory controller 430 of FIG. 4 may initiate an error message in the form of an interrupt or other message indicating the error condition. In response to receiving such an error message in a system such as the computer system of FIG. 1, processor 20 may send a request for service via email or via a dial-up service through a modem for example. In alternative embodiments, a separate processor (not shown) may be used to handle error indications from memory controller 330 or memory controller 430 and may be configured to reconfigure the memory subsystem in response to an error indication.

It is also contemplated that in one embodiment, a faulty DIMM such as DIMM 0-9 may be “hot swappable.” As used herein, hot swappable refers to the ability of a faulty DIMM to be removed and replaced while memory subsystem 350 or memory subsystem 450 continues to operate.

As described above, the ability to recreate the data stored in a given memory module using only the other memory modules in the system memory may make the system more reliable, available and/or serviceable.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A memory subsystem comprising:
a memory controller;
a system memory coupled to said memory controller via a memory interconnect;
wherein said system memory includes a plurality of memory modules each including:
a circuit board; and
a plurality of memory chips mounted to said circuit board;
wherein said memory controller is configured to store portions of a data segment across at least two of said memory modules; and
wherein said memory controller is further configured to store parity of said portions of said data segment in a corresponding location of another of said memory modules.

2. The memory subsystem as recited in claim 1, wherein said memory controller is configured to detect whether an error exists in said portions of said data segment using an associated error code.

3. The memory subsystem as recited in claim 2, wherein said memory controller is configured to recreate at least one of said portions using said parity.

4. The memory subsystem as recited in claim 3, wherein said memory interconnect includes a data path having a plurality of data bits configured to convey said data segment.

5. The memory subsystem as recited in claim 4, wherein each of said plurality of memory modules is coupled to a respective mutually exclusive subset of said data bits.

6. The memory subsystem as recited in claim 5, wherein each of said respective mutually exclusive subset of said data bits is configured to convey one of said portions of said data segment.

7. The memory subsystem as recited in claim 5, wherein each of said respective mutually exclusive subset of said data bits is configured to convey two of said portions of said data segment.

8. A memory subsystem comprising:
a memory controller;
a system memory coupled to said memory controller via a memory interconnect;
wherein said system memory includes a plurality of memory modules each including:
a circuit board; and
a plurality of memory chips mounted to said circuit board;
wherein said memory controller is configured to store respective portions of a data segment across at least two of said memory modules; and
wherein said memory controller is further configured to store parity of at least some of said respective portions of said data segment in a corresponding location of another of said memory modules.

9. The memory subsystem as recited in claim 8, wherein said memory controller is configured to detect whether an error exists in said respective portions of said data segment using an associated error code.

10. The memory subsystem as recited in claim 9, wherein said memory controller is configured to recreate at least one of said respective portions using said parity.

11. The memory subsystem as recited in claim 10, wherein said memory interconnect includes a data path having a plurality of data bits configured to convey said data segment.

12. The memory subsystem as recited in claim 11, wherein each of said plurality of memory modules is coupled to a respective mutually exclusive subset of said data bits.

13. The memory subsystem as recited in claim 12, wherein each respective mutually exclusive subset of said data bits is configured to convey one of said respective portions of said data segment.

14. A memory subsystem comprising:
a memory controller;
a system memory coupled to said memory controller via a memory interconnect;
wherein said system memory includes a plurality of memory modules each including:
a circuit board; and
a plurality of memory chips mounted to said circuit board;
wherein said memory controller is configured to access said system memory in a plurality of slices, each slice including at least one memory module; and
wherein said memory controller is configured to store parity of at least some of said plurality of slices in at least one additional slice.

15. The memory subsystem as recited in claim 14, wherein said memory controller is configured to detect whether an error exists in data associated with said at least some of said plurality of slices using an associated error code.

16. The memory subsystem as recited in claim 15, wherein said memory controller is configured to recreate at least one of said plurality of slices using said parity.

17. The memory subsystem as recited in claim 16, wherein said memory interconnect includes a data path having a plurality of data bits.

18. The memory subsystem as recited in claim 17, wherein each of said plurality of memory modules is coupled to a respective mutually exclusive subset of said data bits.

19. The memory subsystem as recited in claim 18, wherein each of said plurality of memory chips belongs to a respective memory bank of a plurality of memory banks.

20. The memory subsystem as recited in claim 19, wherein each of said plurality of memory banks is coupled to each of said plurality of data bits.

21. The memory subsystem as recited in claim 20, wherein each of said respective mutually exclusive subset of said plurality of data bits belongs to a respective one of said plurality of slices.

22. The memory subsystem as recited in claim 21, wherein each memory chip within a given respective memory bank is coupled to a different subset of said plurality of data bits.

23. A computer system comprising:
a processor configured to execute instructions;
a memory subsystem coupled to said processor via a system bus, wherein said memory subsystem includes:
a memory controller;
a system memory coupled to said memory controller via a memory interconnect;
wherein said system memory includes a plurality of memory modules each including:
a circuit board; and
a plurality of memory chips mounted to said circuit board;
wherein said memory controller is configured to store portions of a data segment across at least two of said memory modules; and
wherein said memory controller is further configured to store parity of said portions of said data segment in a corresponding location of another of said memory modules.

24. The computer system as recited in claim 23, wherein said memory controller is configured to detect whether an error exists in said portions of said data segment using an associated error code.

25. The computer system as recited in claim 24, wherein said memory controller is configured to recreate at least one of said portions using said parity.

26. A computer system comprising:
a processor configured to execute instructions;
a memory subsystem coupled to said processor via a system bus, wherein said memory subsystem includes:
a memory controller;
a system memory coupled to said memory controller via a memory interconnect;
wherein said system memory includes a plurality of memory modules each including:
a circuit board; and
a plurality of memory chips mounted to said circuit board;
wherein said memory controller is configured to store respective portions of a data segment across at least two of said memory modules; and
wherein said memory controller is further configured to store parity of at least some of said respective portions of said data segment in a corresponding location of another of said memory modules.

27. The computer system as recited in claim 26, wherein said memory controller is configured to detect whether an error exists in said respective portions of said data segment using an associated error code.

28. The computer system as recited in claim 27, wherein said memory controller is configured to recreate at least one of said respective portions using said parity.

29. A computer system comprising:
a processor configured to execute instructions;
a memory subsystem coupled to said processor via a system bus, wherein said memory subsystem includes:
a memory controller;
a system memory coupled to said memory controller via a memory interconnect;
wherein said system memory includes a plurality of memory modules each including:
a circuit board; and
a plurality of memory chips mounted to said circuit board;
wherein said memory controller is configured to access said system memory in a plurality of slices, each slice including at least one memory module; and
wherein said memory controller is configured to store parity of at least some of said plurality of slices in at least one additional slice.

30. The computer system as recited in claim 29, wherein said memory controller is configured to detect whether an error exists in data associated with said at least some of said plurality of slices using an associated error code.

31. The computer system as recited in claim 30, wherein said memory controller is configured to recreate at least one of said plurality of slices using said parity.
